(19) United States
(12) Patent Application Publication
(10) Pub. No.: US 2002/0025838 A1
(43) Pub. Date: Feb. 28, 2002

(54) Information communication apparatus

(75) Inventor: Katsuaki Kawamura, Saitama (JP)

Correspondence Address: SUGHRUE, MION, ZINN, MACPEAK & SEAS, PLLC, 2100 Pennsylvania Avenue, N.W., Washington, DC, 20037, US

(73) Assignee: PIONEER CORPORATION

(21) Appl. No.: 09/900,132

(22) Filed: Jul. 9, 2001

(30) Foreign Application Priority Data
Jul. 7, 2000 (JP) P. 2000-207594

(51) Int. Cl. H04M 1/00

(52) U.S. Cl. 455/567; 455/550

(57) ABSTRACT

In the process of reproducing audio signals for music reproduction, vibrations are generated by means of driving a vibrator using a drive signal generated based on the low frequency range components of the reproduced audio signal.

### BACKGROUND OF THE INVENTION

1. Field of the Invention

The invention relates to an information communication apparatus such as a cellular telephone having a vibrator function that generates vibration.

The present disclosure relates to the subject matter contained in Japanese Patent Application No. 2000-207594 filed Jul. 7, 2000, which is incorporated herein by reference in its entirety.

2. Description of the Related Art

A cellular telephone is widely used as an information communication apparatus that allows wireless telephone calls.

The cellular telephone often has an incoming notification vibrator function that notifies the user of incoming information in place of the incoming notification sound when there is an incoming call. The incoming notification vibrator function is achieved by a vibratory motor, which is essentially a small DC motor equipped with an eccentric weight attached to a rotating shaft and which is affixed inside the frame of the cellular telephone. When the cellular telephone receives a call, the eccentric weight rotates as a prescribed drive voltage is applied to the vibratory motor, causing the center of gravity thereof to move around the rotating shaft of the eccentric weight, thus in turn causing the frame to vibrate as a reaction thereto. Consequently, the user recognizes that a call has been received by means of the vibration.

There is a possibility that the cellular telephone may be used not only as a tool for voice communication, but also for playing games, listening to music, enjoying movies, and various other purposes in the future. In the case of such a multi-functional cellular telephone, there may be a need to provide a more realistic and powerful sound, not just simple music from the speaker.

In a case where the cellular telephone is used for the purpose of games and audio reproductions, there is a likelihood that the speaker and the vibratory motor are tied up for other purposes and the receipt of information cannot be made by the speaker and the vibratory motor.

### SUMMARY OF THE INVENTION

An object of the present invention is to solve the above problem and provide an information communication apparatus that is capable of notifying the user of the receipt of information while enjoying powerful audio sound reproductions without fail.

According to the invention, there is provided a information communication apparatus comprising: an information communication unit capable of transmitting and receiving information by communication; a vibration notification unit that notifies of incoming information by means of the vibration; a speaker that outputs audio signals; and a vibration control unit that causes the vibration notification unit to vibrate synchronizing with an audio signal, wherein the vibration control unit drives the vibration notification unit by a driving signal generated by the audio signal. Thus, the information communication apparatus can generate a vibration synchronized with the audio signal by means of driving the vibration notification unit by the drive signal generated by the audio signal.

Preferably, the information communication apparatus comprises a music reproduction unit that outputs music as an audio signal. Thus, the information communication apparatus can generate a vibration synchronized with music by means of driving the vibration notification unit by the drive signal generated by the audio signal outputted by the music reproduction unit. The vibration can enhance particularly the low-pitched tone of the reproduced music by generating the drive signals based on the low frequency components of the music.

Preferably, in the information communication apparatus, the vibration control unit stops the music reproduction performed by the music reproduction unit if the incoming information occurs during music reproduction. Therefore, according to the information communication apparatus, the music reproduction can be interrupted when the information is received, thus making it possible to notify the user of the receipt of information without failure.

### BRIEF DESCRIPTION OF THE DRAWINGS

FIG. 1 is a schematic block diagram of a cellular telephone P1 according to a first embodiment of the invention.

FIG. 2 is an internal block diagram of a drive signal generating unit.

FIGS. 3A to 3C are diagrams showing output signal waveforms at various areas of the drive signal generating unit.

FIG. 4 is a schematic block diagram of a cellular telephone P2 according to a second embodiment of the invention.

FIG. 5 shows an example of the drive signal generating unit.

FIG. 6 is a cross section of a driver.

### DETAILED DESCRIPTION OF THE PRESENT INVENTION

The present invention will be described in detail with reference to the accompanying drawings.

### First Embodiment

A cellular telephone having an audio reproduction capability will be described in addition to the telephone call function and the incoming notification vibrator function according to a first embodiment of the invention.

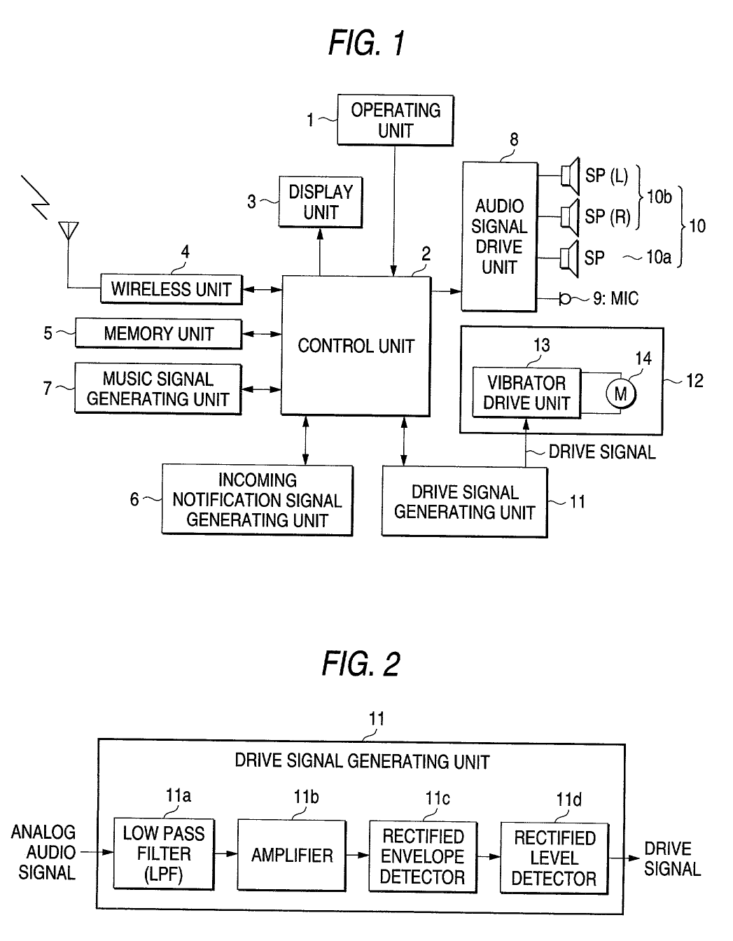

FIG. 1 is a schematic block diagram of a cellular telephone P1 of the first embodiment of the invention. In FIG. 1, the cellular telephone P1 comprises an operating unit 1, a control unit 2, a display unit 3, a wireless unit 4, a memory unit 5, an incoming notification signal generating unit 6, a music signal generating unit 7, an audio signal drive unit 8, a microphone 9, a speaker 10, a drive signal generating unit 11 and a vibrator 12.

The operating unit 1 is for the user to operate various functions including the telephone call function and the audio reproduction function, comprises multiple operating keys provided on a surface of a frame of the cellular telephone, and supplies various signals corresponding to various operations performed by the user to the control unit 2.

The control unit 2 is to control various parts of the cellular telephone P1, and controls various parts in correspondence with the signals from the operating unit 1.

The display unit 3 comprises a liquid crystal display panel, etc., and is provided on the surface of the frame of the cellular telephone P1 together with various operating keys of the control unit 1 to display numerals and characters, etc.

The wireless unit 4 comprises a transmission/reception unit for conducting wireless communication, and performs according to the control of the control unit 2 transmission and reception of voice communication as well as reception of music data delivered by external sources. The music data includes general music score data that allows the user to enjoy music as well as incoming notification audio data used for the incoming notification sound of the cellular telephone P1.

The memory unit 5 comprises, for example, a RAM in which information can be written or erased, and stores various information such as telephone numbers and music data.

The incoming notification signal generating unit 6 reads the incoming notifying signal sound data stored in the memory unit 5 upon receiving incoming information, generates an analog audio signal to be used as the incoming notification sound from the incoming notification sound data and supplies the analog audio signal to the audio drive unit 8 and the drive signal generating unit 11.

The music signal generating unit 7 reads the music data stored in the memory unit 5, generates an analogy audio signal from the music data, and supplies the analog audio signal to the audio drive unit 8 and the drive signal generating unit 11 via a signal supply line.

The audio signal drive unit 8 selects the analog audio signal supplied either by the incoming notification signal generating unit 6 or the music signal generating unit 7, amplifies the analog audio signal, and supplies the analog audio signal to the speaker 10. The audio signal drive unit 8 performs signal processing of the user's voice picked up by the microphone 9 and the caller's voice supplied to the speaker 10.

The speaker 10 comprises a voice speaker 10a and an audio speaker 10b. The voice speaker 10a is a speaker dedicated to telephone calls and outputs the caller's voice supplied by the audio signal drive unit 8.

The audio speaker 10b is a speaker designed to output music and the incoming notification sound and outputs the analog audio signal supplied by the audio signal drive unit 8. The audio speaker 10b comprises two speakers to output two systems of audio signals, i.e., L-ch and R-ch.

The drive signal generating unit 11 is to generate drive signals for driving the vibrator 12, which will be described in detail later, selects the analog signal supplied by either the incoming notification signal generating unit 6 or the music signal generating unit 7, generates a drive signal based on the analog signal, and supplies the drive signal to the vibrator 12.

When the selected analog audio signal is a stereo signal consisting of two channels of signals, i.e., L-ch analog signal and R-ch analog signal, the drive signal generating unit 11 can use the drive signal of one of the two systems, or use a signal synthesized from the signals of the two systems.

The audio signal drive unit 8 and the drive signal generating unit 11 are formed to select the same analog audio signal with help from the control unit 2.

The vibrator 12 is to generate vibrations corresponding to the drive signal supplied by the drive signal generating unit 11, and comprises a vibrator drive unit 13 and a vibratory motor 14. The vibrator drive unit 13 generates a vibrator drive signal based on the drive signal supplied by the drive signal generating unit 11, and supplies the signal to the vibratory motor 14. The vibrator drive signal is obtained by amplifying a pulse wave-shaped drive signal supplied by the drive signal generating unit 11 to drive the vibratory motor 14. The vibratory motor 14 comprises a small DC motor with a small eccentric weight mounted on a rotating shaft thereof, and creates a vibration when it is turned on by the vibrator drive signal supplied by the vibrator drive unit 13.

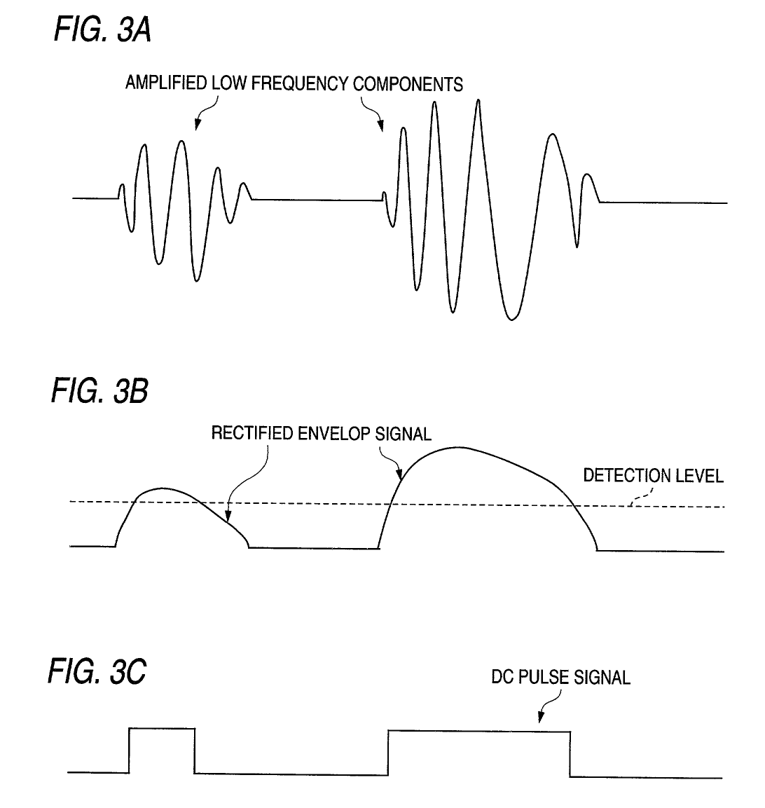

Now, a method of generating drive signals to be generated by the drive signal generating unit 11 will be described with reference to FIGS. 2 and 3. FIG. 2 is an internal block diagram of the drive signal generating unit 11. The drive signal generating unit 11 comprises a low pass filter (LPF) 11a, an amplifier 11b, a rectified envelope detector 11c, and a rectified level detector 11d.

FIGS. 3A to 3C show output signal waveforms at various parts of the drive signal generating unit 11 shown in FIG. 2, where FIG. 3A shows the output signal waveform of the amplifier 11b of the drive signal generating unit 11, FIG. 3B shows the output signal waveform of the rectified envelope detector 11c, and FIG. 3C shows the output signal waveform of the rectified level detector 11d, i.e., the waveform of the drive signal output.

The LPF 11a is a low pass filter, which extracts only the low frequency range components of the analog audio signal supplied by the incoming notification signal generating unit 6 or music signal generating unit 7, and supplies the extracted low frequency range signal to the amplifier 11b in the next step.

The amplifier 11b amplifies the input low frequency range signal at a specified gain value (FIG. 3A) and supplies it to the rectified envelope detector 11c.

The rectified envelope detector 11c further envelope-rectifies the amplified low frequency range signal after rectifying to generate the rectified envelope signal shown in FIG. 3B, and supplies it to the rectified level detector 11d.

The rectified level detector 11d generates from the supplied rectified envelope signal to a DC pulse signal (FIG. 3C) using a threshold value of a specified detection level (shown by the dotted line in FIG. 3B), and supplies it as a drive signal to the vibrator 12.

Thus, the drive signal generating unit 11 is capable of generating a drive signal that generates vibrations at the vibrator 12 only when the analog audio signal has specified low frequency range signal components and the low frequency range signal components maintain a certain level, i.e., generating vibrations synchronous with the low frequency range signal components of the analog audio signal.

Next, the specifics of control in the audio reproduction function of the cellular telephone P1 will be described.

The audio reproduction function comprises a music reproduction mode that reproduces music data stored in the memory unit 5 and an incoming notification sound reproduction mode that reproduces incoming notification data stored in the memory unit 5.

First, the music reproduction mode will be described. When an instruction for selecting the music data stored in the memory unit 5 is generated from the control unit 1, the music signal generating unit 7 reads the music data specified by the instruction from the memory unit 5, generates an analog audio signal based on the read music data, and supplies the analog audio signal to the audio signal drive unit 8 and the drive signal generating unit 11 in sequence.

Next, the audio signal drive unit 8 selects the analog audio signal supplied by the music signal generating unit 7 as specified by the instruction of the control unit 2, amplifies the analog audio signal and supplies it to the speaker 11b. The speaker 10b outputs a voice when the amplified analog audio signal is supplied.

The drive signal generating unit 11 selects the analog audio signal supplied by the music signal generating unit 7 as specified by the instruction from the control unit 2, and supplies the drive signal generated by the above-mentioned method to the vibrator drive unit 13. A drive signal is now generated which reaches a high level only when the analog audio signal maintains the specified low frequency range components and also the specified signal level. The vibrator drive unit 13 amplifies the drive signal and supplies it to the vibratory motor 14. Thus, the vibratory motor 14 is driven to generate vibrations only when the drive signal is at a high level.

As a result, the audio speaker 10b outputs the reproduced music sound based on the music data at the same time, from vibratory motor 14 of the vibrator 12 vibrations are generated synchronous with the low frequency range components of the music according to the music data. Consequently, the user of the cellular telephone P1 can sense music both by sound and vibration to enjoy music with a full ambient feeling. In particular, by generating vibrations based on low frequency range components of the music, the low-pitched tone can be enhanced.

Next, the incoming notification sound reproduction mode will be described. The user instructs selection of the incoming notification sound data stored in the memory unit 5 from the operating unit 1 in advance. The above-mentioned music data can be selected instead of the incoming notification sound data in this case. When an incoming call is detected, the incoming notification signal generating unit 6 reads the pre-specified incoming notification sound data from the memory unit 5, generates the analog audio signal based on the read incoming notification sound data, and supplies it to the audio signal drive unit 8 and the drive signal generating unit 11 in sequence.

The audio signal drive unit 8 supplies the supplied analog audio signal to the speaker 10b to cause it to output the incoming notification sound. Moreover, the drive signal generating unit 11 causes the vibrator 12 to vibrate based on the supplied analog audio signal at this time. Since this operation is similar to the operation in the music reproduction mode, detailed descriptions are omitted here. As a consequence, it is ensured that the user of the cellular telephone P1 senses the incoming notification sound through both sound and vibration.

If there is an incoming call while music is being reproduced by means of the music reproduction mode, the control unit 2 completes the reproduction operation of the analog audio signal by means of the music signal generating unit 7, and starts the reproduction operation of the analog audio signal by means of the incoming notification signal generating unit 6. In other words, the speaker 10b outputs the incoming notification sound instead of the music being reproduced. Therefore, the user can recognize the incoming call even during music reproduction without failure. When communication is completed, the music reproduction mode goes into a pending status, and will not restart music reproduction until it receives an instruction “to restart music reproduction” from the operating unit 1.

The control unit 2 can also be configured to interrupt the music reproduction mode when there is an incoming call, remembers the reproduction status just before the interruption, and restarts the music reproduction operation from the point of interruption when communication is completed. The reproduction status includes the volume of the sound, the name of the interrupted score, the interruption address of the interrupted score, the order of reproduction of scores, and other information relevant to the music reproduction mode. Thus, the user can restart the music from a status just before the incoming call arrived, eliminating the need to reset the music reproduction.

Although it was assumed in the first embodiment described above that the vibrator 12 is equipped with a DC vibratory motor 14 as the vibration source, the invention is not limited to the configuration, and a vibrator using an AC vibration driver can be used as well.

### Second Embodiment

A second embodiment of the invention will be described which is formed using devices below.

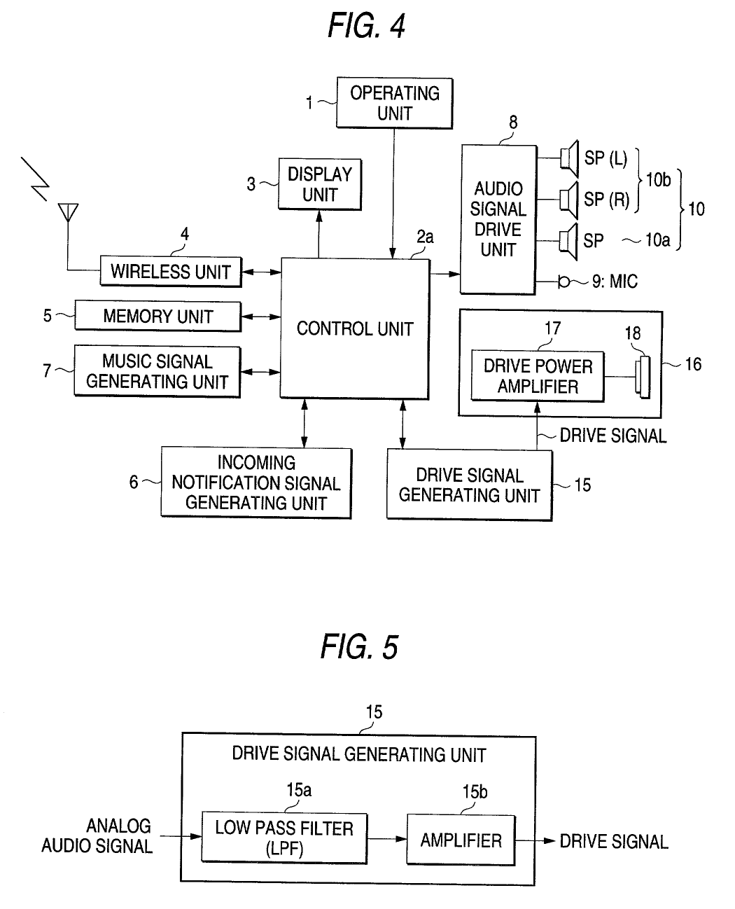

FIG. 4 is a schematic block diagram of a cellular telephone P2 in the second embodiment of the invention. As shown in FIG. 4, the cellular telephone P2 comprises all the components of the cellular telephone P1 described above except the replacements of the drive signal generating unit 11 and the vibrator 12 with a drive signal generating unit 15 and a vibrator 16 respectively. Therefore, in order to avoid duplication of the descriptions in the first embodiment, we will concentrate on descriptions of the constitutions and operations of the drive signal generating unit 15 and the vibrator 16.

FIG. 5 is an example of the drive signal generating unit 15. The drive signal generating unit 15 comprises a LPF 15a and an amplifier 15b, both identical to those in the drive signal generating unit 11 described before. Since the LPF 15a and the amplifier 15b are respectively identical to the LPF 11a and the amplifier 11b described before, their descriptions are omitted here.

The vibrator 16 comprises a drive power amplifier 17 and a driver 18 as shown in FIG. 4. The drive power amplifier 17 is a drive circuit for driving the driver 18 and is used to power-amplify and supply the drive signal supplied by the drive signal generating unit 15 to the driver 18.

The driver 18 is a kind of electromechanical vibration converter, and is capable of generating vibrations in accordance with the drive signal power-amplified drive signal supplied by the drive power amplifier 17.

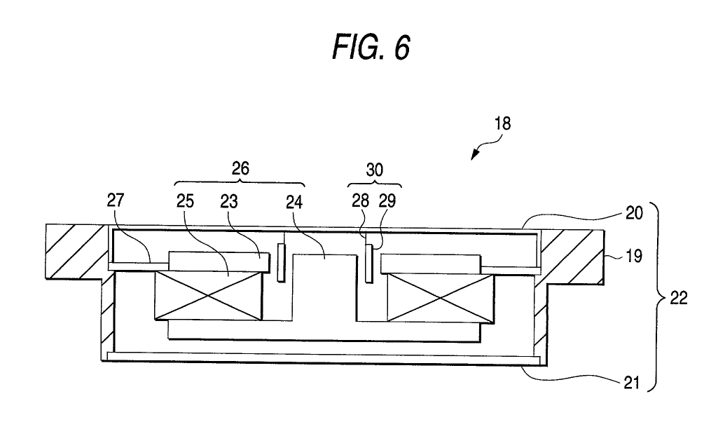

As shown in FIG. 6, the driver 18 comprises:

a case 22 having a hollow internal space, which includes a frame 19 made of metallic material or resin whose openings on both ends are covered with circular plates 20 and 21 made of metallic material or resin;

an external magnet shaped magnetic circuit 26 including a ring plate shaped ring plate 23, a pole yoke 24 and a ring shaped magnet 25;

a damper 27 including a ring plate shaped elastic member; and

a voice coil 30 including a coil 29 cylindrically wound on a cylindrical coil support member 28.

The magnetic circuit 26 is installed on the internal circumference of the damper 27 in the internal space of the case 22. The outer circumference of the damper 27 is mounted on the frame 19. Thus, the magnetic circuit 26 is suspended in the internal space of the case 22 by being elastically supported by the damper 27.

A coil supporting member 28 of the voice coil 30 is affixed to a portion of the plate 20, which faces a ring shaped gap of the magnetic circuit 26, and at least a portion of the coil 29 is placed in the magnetic gap of the magnetic circuit 26, which is floatingly supported by the damper 27. Also, both ends of the coil 29 are extended from the internal space of the case 22 to the outside and connected to the electrical input terminals (not shown) of the case 22.

The case 22 of the driver 18 is affixed to the frame of the cellular telephone P2 in the second embodiment.

Various parts of the driver 18 are constituted as described above. When the power-amplified drive signal is supplied to the electrical input terminal from the drive power amplifier 17, the current corresponding to the drive signal flows to the coil 30 placed inside the magnetic gap of the magnetic circuit 26 and, as a result, a force approximately proportional to the current is generated along the axial direction of the cylindrical coil 30. Thus, the case 22 that includes the voice coil 30 and the magnetic circuit 26 creates relative vibrations corresponding to the force generated.

Thus, the driver 18 by itself has a mechanical resonance system with one degree of freedom, where the mass of case 22 including the voice coil 30 and the mass of magnetic circuit 26 are connected in series via the compliance of the damper 27. However, since the case 22 of the driver 18 is affixed to the frame of cellular telephone P2, it constitutes a mechanical resonance system with one degree of freedom having one self-resonance frequency since the mass of case 22 includes the voice coil 30 added with the mass of the cellular telephone P2, whereby they are connected in series via the compliance of damper 27.

As a result, the driver 18 affixed to the frame of the cellular telephone P2 at the case 22 has a vibration frequency characteristic having a peak centered around the above-mentioned self-resonance frequency. In other words, the driver 18 is driven efficiently in the vicinity of the self-resonance frequency. Therefore, it is preferable that the drive signal for driving the driver 18 is generated by the drive signal generating unit 15 based on the low frequency range signal components that contain signal components in the vicinity of the self-resonance frequency. Therefore, it is preferable that the LPF 11a of the drive signal generating unit 15 is generated to include the self-resonance frequency of the driver 18 within the low frequency pass range.

The self-resonance frequency of the driver 18 of the cellular telephone P2 described above can be arbitrarily set in a low range frequency in the vicinity of 100 Hz so that people can sense vibrations more efficiently by adjusting its mass and compliance.

The analog audio sound signal is supplied to drive signal generating unit 15 from the incoming notification signal generating unit 6 and the music signal generating unit 7 in the same manner as cellular telephone P1 described above. The drive signal generating unit 15 supplies the supplied analog audio signal to the LPF 15a to have the specified low frequency range signal extracted, and supplies the low frequency range signal to the amplifier 15b in the next step. The amplifier 15b amplifies the low frequency range signal to generate the drive signal and supplies it to the drive power amplifier 17. In other words, the low frequency signal itself is used as the drive signal in the second embodiment.

The drive power amplifier 17 power-amplifies the drive signal consisting of the low frequency range signal and supplies it to the driver 18. Thus, the driver 18 can generate vibrations that correspond to the low frequency range signal.

Although it is assumed in the second embodiment that the driver 18 by itself has a mechanical resonance system with one degree of freedom, and also constitutes a mechanical frequency system with one degree of freedom having one self-resonance frequency in conjunction with the frame since the case 22 of the driver 18 is affixed to the frame of the cellular telephone P2, the case 22 of the driver 18 does not necessarily have to be affixed to the frame of the cellular telephone P2; for example, the case 22 can be affixed to the frame via an elastic member such as a rubber packing.

In such a case, the vibrator 16 will have a mechanical resonance system of a higher degree of freedom since the elastic member sandwiched between case 22 of driver 18 and the frame of the cellular telephone P2 constitutes a compliance factor of the mechanical vibration system. Moreover, the driver does not necessarily need to be constituted to have a self-resonance frequency by itself and can be constituted with multiple mechanical resonance systems having higher than two degrees of freedom. Therefore, while the vibrator may have multiple self-resonance frequencies in such a case, those self-resonance frequencies can be arbitrarily set by adjusting the mass of the elastic member and the frame, the mass of each component of the driver, and the compliance of the damper to provide appropriate constants.

Although it is assumed in each of the first and second embodiments described above that the speaker 10 comprises the voice speaker 10a and the audio speaker 10b, the speakers to be used are not limited to those and can be of any arbitrary constitution as long as the user can hear the incoming notification sound, the speech of the caller, and the reproduced music sound; for example, it can be one or more speakers that can commonly output these reproduced sounds.

Although the drive signal is generated based on the low frequency range signal of the analog audio signal in each of the first and second embodiments described above, the invention is not limited to that; for example, the drive signal can be generated using the wide range, middle range or total range analog audio signal.

Although it is assumed in each of the first and second embodiments described above that the audio signal drive unit 8 and the drive signal generating unit 11 are constituted to select the same analog audio signal at all times, the invention is not limited to such a constitution, but rather it can be constituted in such a way that they select different analog audio signals.

Although it is described in each of the first and second embodiments mentioned above that the cutoff frequency of the LPF 11a that constitutes the drive signal generating unit, the gain value of the amplifier 11b, and the detection level threshold value of the rectified level detector 11d are all constants, the invention is not limited to these, but rather it can be constituted in such a way that the user can arbitrarily change those values, or that they can be changed according to the volume levels of the signal level of the analog audio signal and the level of the volume outputted from the speaker. Thus, the effect of the vibration can be adjustable. For example, the gain value can be reduced if the volume is too small, or can be increased if the volume is too large to adjust the effect of the vibration according to the level of the volume.

According to the invention, the user can sense by both sound and vibration as a drive signal is generated based on the audio signal and the vibrator is made to vibrate in coordination with the sound. In particular, by causing the vibrator to vibrate synchronous with the low frequency range components of the sound, the low frequency sound can be enhanced.

If the information communication apparatus, according to the invention, is used for purposes other than telephone calls, it is possible to notify the user without fail in order to interrupt such usage, when there is an incoming call.

Since the vibration unit can be shared with the vibration notification unit that notifies of an incoming call by means of vibrations, which has been built into the cellular telephone of the prior art, there is no need for adding a new vibration unit in this invention and the objective can be easily achieved by simply supplying the drive signal based on the audio signal to the vibration notification unit.

What is claimed is:

1. An information communication apparatus comprising:
an information communication unit for transmitting and receiving information through communication;
a vibration notification unit for vibrating to notify the reception of the information; and
a vibration control unit for generating from an audio signal a driving signal synchronously with the audio signal, the vibration control unit for causing the vibration notification unit to vibrate according to the driving signal.

2. The information communication apparatus as claimed in claim 1, further comprising a music reproduction unit for outputting music as the audio signal.

3. The information communication apparatuses as claimed in claim 2 wherein the vibration control unit generates the driving signal based on low frequency components of the audio signal.

4. The information communication apparatus as claimed in claim 2 wherein the music reproduction unit stops music reproduction if the information communication unit receives the information during music reproduction.

5. The information communication apparatus as claimed in claim 2 wherein the music reproduction unit comprises an incoming status detection unit for detecting start and completion of receiving the information; and
the music reproduction unit stops music reproduction when the incoming status detection unit detects that the information communication unit receives information, and restarts the music reproduction when the incoming status detection unit detects that the information communication unit completes receiving the information, if the information is received during music reproduction.

6. The information communication apparatus as claimed in claim 3, wherein the vibration notification unit comprises a vibration unit for vibrating with a self-resonance frequency; and
wherein the vibration control unit comprises a low pass filter having a passing frequency band for passing the low frequency components including the self-resonance frequency of the vibration unit.

7. The information communication apparatus as claimed in claim 3, wherein the vibration notification unit comprises a vibration unit for vibrating the information communication apparatus according to the driving signal; and
wherein the vibration control unit comprises a low pass filter having a passing frequency band for passing the low frequency components of the audio signal.

8. The information communication apparatus as claimed in claim 7, wherein the vibration control unit further comprises an amplifier for amplifying the low frequency components passing through the low pass filter.

9. The information communication apparatus as claimed in claim 8, wherein the vibration control unit further comprises a rectifier for rectifying the low frequency components output from the amplifier to generate the driving signal.

10. The information communication apparatus as claimed in claim 2, wherein the information received by the information communication unit includes voice communication data from an external terminal and music data delivered from an external source.

11. The information communication apparatus as claimed in claim 10, wherein the music reproduction unit outputs the music as the audio signal based on the music data delivered from the external source.

12. The information communication apparatus as claimed in claim 10, further comprising a memory for storing the music data.

13. The information communication apparatus as claimed in claim 12, wherein the music reproduction unit generates and outputs the music as the audio signal based on the music date in the memory.

14. The information communication apparatus as claimed in claim 1, further comprising a speaker for outputting the audio signal.
